(19) United States
(12) Patent Application Publication
(10) Pub. No.: US 2022/0213894 A1
(43) Pub. Date: Jul. 7, 2022

(54) SCROLL PUMP CRANK SLEEVE

(71) Applicant: Edwards Limited, Burgess Hill, Sussex (GB)

(72) Inventors: Alan Ernest Kinnaird Holbrook, Burgess Hill, Sussex (GB); Nigel Paul Schofield, Burgess Hill, Sussex (GB); David Bedwell, Burgess Hill, Sussex (GB)

(21) Appl. No.: 17/606,281

(22) PCT Filed: Apr. 24, 2020
(86) PCT No.: PCT/GB2020/051019

§ 371 Date: Oct. 25, 2021

(30) Foreign Application Priority Data
Apr. 26, 2019 (GB) 1905833.8

(51) Int. Cl. F04C 29/00; F04C 18/02

(52) U.S. Cl. CPC F04C 29/0021; F04C 18/0215; F04C 2240/807; F04C 2240/60; F04C 2240/50

(57) ABSTRACT

The invention provides a crank sleeve for a scroll pump. The crank sleeve has a longitudinal axis and is configured to provide a radially extending crank offset for imparting an orbital path on an orbital scroll of the scroll pump. The crank sleeve further comprises an integrally formed counterbalance for reducing pump vibration extending radially in a direction substantially opposite to the crank offset.

### CROSS-REFERENCE OF RELATED APPLICATION

This application is a Section 371 National Stage Application of International Application No. PCT/GB2020/051019, filed Apr. 24, 2020, and published as WO 2020/217066 A1 on Oct. 29, 2020, the content of which is hereby incorporated by reference in its entirety and which claims priority of British Application No. 1905833.8, filed Apr. 26, 2019.

### FIELD

The present invention relates to scroll pumps, in particular vacuum scroll pumps, and specifically crank sleeves for scroll pumps.

### BACKGROUND

Known scroll compressors, or pumps, comprise a fixed scroll, an orbiting scroll and a drive mechanism for the orbiting scroll. The drive mechanism is configured to cause the orbiting scroll to orbit relative to the fixed scroll to cause pumping of a fluid between a pump inlet and a pump outlet. The fixed and orbiting scrolls each comprise an upstanding scroll wall extending from a generally circular base plate. Each scroll wall has an end, or tip, face disposed remote from and extending generally perpendicular to the respective base plate. The orbiting scroll wall is configured to mesh with the fixed scroll wall during orbiting of the orbiting scroll so that the relative orbital motion of the scrolls causes successive volumes of gas to be enclosed in pockets defined between the scroll walls and pumped from the inlet to the outlet.

A rotary machine with an attached eccentric mass will have unbalanced internal loads. Accordingly, scroll pumps are inherently unbalanced. Unbalanced internal loads may be reduced or cancelled by a counterbalance mechanism. In the case of scroll pumps, the mass of the orbiting scroll creates an unbalance force in the direction of the crank offset. Consequently, a counterbalance may be added in the opposite direction to reduce the vibration level of the pump.

Referring to FIG. 1, which shows a known crank sleeve in situ, the conventional approach to balancing scroll pumps is to use a separate counterbalance (1) in conjunction with a crank sleeve (2). A crank sleeve (2) is an eccentric member with a centre of rotation offset to the centre of rotation of the drive shaft; thereby providing the crank offset. The crank offset imparts an orbital path on the orbital scroll of the scroll pump. In known systems, a key (3) or pin is required to align the counterbalance (1) opposite to the crank offset.

There is, however, an ongoing need for improved scroll pumps and, in particular, a need for components that aid the manufacture and/or allow for the miniaturisation of scroll pumps for certain applications. The invention addresses, at least to an extent, these and other issues with known scroll pumps and crank sleeves.

The discussion above is merely provided for general background information and is not intended to be used as an aid in determining the scope of the claimed subject matter. The claimed subject matter is not limited to implementations that solve any or all disadvantages noted in the background.

### SUMMARY

Accordingly, in a first aspect the invention provides a crank sleeve for a scroll pump, preferably a vacuum scroll pump. The crank sleeve has a longitudinal axis and provides a radially extending crank offset for imparting an orbital path on an orbital scroll of the scroll pump. The crank sleeve further comprises an integrally formed counterbalance for reducing pump vibration. The counterbalance extends radially in a direction substantially opposite to the crank offset.

Advantageously, crank sleeves according to the invention may provide intrinsic alignment of the orbiting mass and the counterbalance. They further remove the need for a key or pin, reducing the number of parts, from three or more to one, and simplify manufacture.

Typically, the crank sleeve comprises a first portion which is eccentric and, in use, provides the crank offset. Typically, the first portion is coupled to a bearing unit. In this regard, the first portion may preferably have an outer surface which directly engages the bearing unit; typically, by means of an interference fit. The extent of the first portion may be defined by the portion of the crank sleeve, in use, surrounded by or coupled to the bearing unit. Typically, the crank sleeve comprises a second portion which is defined by the distally extending remainder of the crank sleeve, including the counterbalance. An optional third portion may include a proximally extending remainder of the crank sleeve.

Typically, the crank sleeve comprises a conduit for receiving a drive shaft of the scroll pump. The conduit may extend further in a longitudinal direction than the first portion of the sleeve, preferably further in a distal direction. Typically, the conduit extends through, or is defined by, both the first portion and second portion of the crank sleeve. In embodiments the ratio of the length of the conduit defined by the first portion of the crank sleeve to the full length of the conduit is from about 1:1.3 to about 1:3, preferably from about 1:1.5 to about 1:2.5, about 1:2 being an example.

Advantageously, such crank sleeves may be more stably attached to the drive shaft, reducing tolerances and improving pump performance, whilst still affording the aforementioned reduction in part count and simplification of manufacture.

Unless stated otherwise, for the purpose of the invention, axial and longitudinal directions relate to a direction substantially parallel to the axis of rotation of the crank sleeve and/or drive shaft of the pump. Radially refers to a direction extending out from the axis of rotation of the sleeve and/or drive shaft in direction transverse to the longitudinal direction.

Preferably, the bearing unit, or orbiting scroll bearing as it may be known, is a rolling element bearing, preferably the rolling elements are balls. Typically, the portion of the crank sleeve providing the crank offset has an external surface coupled to a bearing unit, preferably the inner race of a rolling element bearing, preferably directly engaged with the inner race of the rolling element bearing. The outer race of the rolling element rotor bearing is typically coupled to the orbiting scroll. Thus, the crank offset may be transmitted to the orbiting scroll via the rolling element bearing.

Preferably the crank sleeve is machined from a single piece of material, typically a metallic substrate. Preferred alloys may include steels, in particular mild steel and stainless steel. It will be appreciated that the user may select an appropriate material, in particular a preferred grade of steel, depending on the application requirements.

The invention further provides a scroll pump, and preferably a scroll vacuum pump, comprising a crank sleeve according to the previous aspect of the invention. The scroll pump may be a dry pump in which the scrolls are not lubricated.

Preferably, scroll pump comprises an orbiting scroll and a fixed scroll and the crank sleeve biases the orbiting scroll bearing in a fixed scroll direction. Orbiting scroll refers to the scroll that orbits during use of the scroll. It will be appreciated that the orbiting scroll may itself be stationary when the pump is not in use. Preferably, scroll pump comprises a drive shaft and the crank sleeve is received on a drive shaft of the scroll pump. Preferably, the crank sleeve is fixed to the drive shaft using a selectively reversible fixation. Typically, the selectively reversible fixation is an orbiting scroll bias which biases the orbiting scroll in a fixed scroll direction.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

In the following disclosure, which is given by way of example only, reference will be made to the drawings, in which:

FIG. 1 is a schematic representation of a prior art scroll pump crank sleeve and counterbalance; and

FIG. 2 is a schematic representation of a crank sleeve according to the invention.

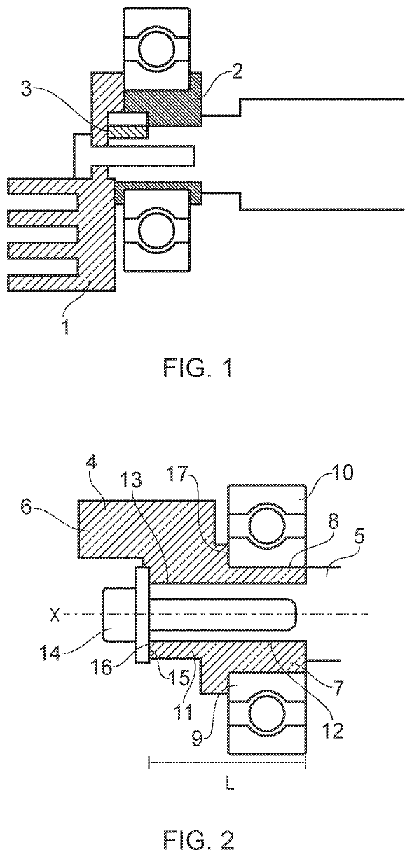

### DETAILED DESCRIPTION

The present invention provides a crank sleeve for a scroll pump, preferably a vacuum scroll pump.

Referring to FIG. 2, the illustrated crank sleeve (4) is an eccentric member with a centre of rotation parallel to, but radially offset from, the axis of rotation (X) of the drive shaft (5). The eccentricity of the crank sleeve (4) provides a crank offset which, in use, imparts an orbital path on the orbital scroll of the scroll pump (not shown). The crank offset extends in a first radial direction substantially perpendicular to the axis of rotation of the drive shaft (5) and/or the crank sleeve (4).

The illustrated crank sleeve (4) further comprises an integrally formed counterbalance (6) for reducing pump vibration. The counterbalance (6) extends radially in a direction substantially opposite to the crank offset. The counterbalance (6) typically extends further radially than the crank offset. The mass and geometry of the counterbalance (6) will be determined by the mass and geometry of the orbiting scroll and the extent of the crank offset.

Advantageously, the illustrated crank sleeve (4) removes the need for a key and provides intrinsic alignment of the orbiting mass and the counterbalance, reducing the number of parts and easing manufacture.

The illustrated crank sleeve (4) comprises a first portion (7) defined by an outer surface (8) which engages the inner race (9) of the bearing unit (10). A second portion (11) is defined by the distally extending remainder of the crank sleeve (4), including the counterbalance (6). The first portion (7) is eccentric and provides the crank offset. The first (7) and second (11) portions are integrally formed. The illustrated crank sleeve (4) is made (e.g. machined) from a single piece of material, in this instance mild steel. Typically, the crank sleeve (4) is formed by machining.

As illustrated, the crank sleeve (4) comprises a conduit (13) for receiving the drive shaft (5) of the scroll pump. The conduit comprises an inner surface (12) which, in use, engages an outer surface of the drive shaft (5). Typically, the inner surface (12) of the conduit is configured to circumferentially engage with the outer surface of the drive shaft (5) along substantially the entire length (L) of the conduit (13).

An axial thrust is provided to the crank sleeve (4) by an orbiting scroll biaser (14). The scroll biaser (14) is located at a distal end of the drive shaft (5). The thrust provided by the biaser (14) may be varied to ensure an adequate seal is obtained without damaging the scroll components.

The illustrated orbiting scroll biaser (14) comprises an abutment surface (15) which engages the crank sleeve (4). The abutment surface (15) of the orbiting scroll biaser (14) extends in a plane transverse to the axis of rotation of the drive shaft (5) and engages with an abutment surface (16) provided on the crank sleeve (4). The abutment surface (16) of the crank sleeve is substantially parallel to the abutment surface (15) of the orbiting scroll biaser (14). The illustrated crank sleeve abutment surface (16) is located in the second portion (11) of the crank sleeve (4). The axial thrust provided by the orbiting scroll biaser (14) is arranged to securely push the orbiting scroll into contact with the fixed scroll.

The crank sleeve (4) transmits the axial thrust to the orbiting scroll via the bearing unit (10). In this regard, the crank sleeve (4) comprises a second abutment surface (17) extending transverse to its axis of rotation, which, in use, engages a bearing unit (10). The second abutment surface (17) is typically located in the second portion (11) of the crank sleeve (4).

The force exerted by the orbiting scroll biaser (14) should be sufficient to overcome the pressure loads generated in use of the scroll pump that will tend to force the fixed and orbiting scroll apart. The force provided by the orbiting scroll biaser (14) should be sufficient to balance this pressure loading and cause sufficient engagement between the base and opposed tip faces of the scrolls to provide a reliable seal.

The crank sleeve (4) is configured to reversibly couple to the drive shaft (5) and bearing unit (10), for instance using an interference fit. In the illustrated example, the bearing unit (10) is a ball bearing.

It will be appreciated that various modifications may be made to the embodiments shown without departing from the spirit and scope of the invention as defined by the accompanying claims as interpreted under patent law.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A crank sleeve for a scroll pump, said crank sleeve having a longitudinal axis and being configured to provide a radially extending crank offset for imparting an orbital path on an orbital scroll of the scroll pump, said crank sleeve further comprising an integrally formed counterbalance for reducing pump vibration extending radially in a direction substantially opposite to the crank offset.

2. The crank sleeve according to claim 1, the crank sleeve comprising a first portion which is eccentric and, in use, provides the crank offset.

3. The crank sleeve according to claim 2, the crank sleeve comprising a second portion, longitudinally offset from the first portion, which comprises the counter balance.

4. The crank sleeve according to claim 2, the crank sleeve further comprising a conduit for receiving a drive shaft of the scroll pump.

5. The crank sleeve according to claim 4, the conduit having a length in longitudinal direction that is longer than the first portion.

6. The crank sleeve according to claim 4, wherein the ratio of the length of the conduit defined by the first portion of the crank sleeve to the full length of the conduit is from about 1:1.3 to about 1:3, preferably from about 1:1.5 to about 1:2.5.

7. The crank sleeve according to claim 1, wherein the crank sleeve has an external surface coupled to a bearing unit, preferably the inner race of a rolling element bearing.

8. The crank sleeve according to claim 1 wherein the crank sleeve is machined from a single piece of material.

9. A scroll pump comprising a crank sleeve according to claim 1.

10. The scroll pump according to claim 9 wherein the crank sleeve is coupled to an orbiting scroll bearing and biases the orbiting scroll bearing in a fixed scroll direction.

11. The scroll pump according to claim 10 wherein the crank is received on a drive shaft of the scroll pump, said drive shaft comprising a non-permanent fixation for attaching the crank sleeve to the drive shaft, said non-permanent fixation providing said bias to the orbiting scroll bearing.
